(19) United States
(12) Patent Application Publication
(10) Pub. No.: US 2008/0034511 A1
(43) Pub. Date: Feb. 14, 2008

(54) Laundry Treatment Compositions

(76) Inventors: Stephen Norman Batchelor, Bebington (GB); Jayne Michelle Bird, Bebington (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 11/663,576

(22) PCT Filed: Sep. 12, 2005
(86) PCT No.: PCT/EP05/09884

§ 371 Date: Mar. 23, 2007

(30) Foreign Application Priority Data
Sep. 23, 2004 (GB) 0421147.0
Apr. 27, 2005 (GB) 0508486.8

(51) Int. Cl. C11D 3/40

(52) U.S. Cl. 8/675

(57) ABSTRACT

The present invention provides a treatment composition comprising a hydrophobic dye, having an anthraquinone structure and surfactant. A method of treating a textile with said composition is also claimed.

### TECHNICAL FIELD

The present invention relates to laundry treatment compositions that comprise a dye.

### BACKGROUND OF THE INVENTION

Garments comprising polyester fibres are ubiquitous. Many garments are white but over the lifetime of these garments the whiteness is dulled reducing the aesthetic value of the garment. There is a need to maintain the white appearance of such garments such that the aesthetic value is retained as long as possible.

Bleach, fluorescers and shading agents are used in modern wash processes to maintain whiteness. The fluorescers and shading agents that are currently available, do not deposit on polyester fibres of garments to a significant degree. All fibres may be subjected to a bleaching process but over time such treatment can lead to the garment taking a yellow hue.

U.S. Pat. No. 3,958,928 discloses a dye composition together with methods for its use. The dye composition is a mixture of anthraquinone dyes suitable for use with liquid laundry detergents. The composition substantially reduces the undesirable fabric staining characteristic of a detergent in which the dye is employed, while still retaining the ability to blue the fabric. The composition is a combination of an oil soluble dye such as 1,4-bis(2-ethylhexylamino)-anthraquinone (C.I. Solvent Blue 58) with a water soluble dye such as 1-amino-2-sulfo, 4-(2-sulfo-para toluidino) anthraquinone sodium salt (C.I. Acid Blue 145) and/or 1,4-bis(3-sodium sulfonate mesitylidino) anthraquinone (C.I. Acid Blue 80). The dye disclosed has two eight carbon branched substituents. Long alkyl chains aid the incorporation of the highly hydrophobic dye in water surfactant compositions. Surprisingly a wide range of disperse and solvent anthraquinone dyes without long alkyl chains are discovered which have much better function as shading dyes from homogeneous (isotropic) liquid laundry or granular formulations.

U.S. Pat. No. 6,521,581 discloses the use of anthraquinone dyes in a bi-phase (anisotropic) liquid detergent composition with high levels of coloured inorganic salts.

There is a need to provide technology that maintains and enhances the white appearance of polyester comprising garments.

### SUMMARY OF THE INVENTION

Dyes disclosed herein are known to be used to dye textiles in industrial processes conducted at high temperatures together with high concentrations of dyes and dispersion agents. Surprisingly the dyes can be used to shade at low levels of dye and surfactant and at routine laundry temperatures. We have found that hydrophobic dyes are substantive to polyester fibres under normal domestic wash conditions. At low levels of dye a shading whiteness benefit is provided.

In one aspect the present invention provides a granular or isotropic liquid laundry treatment composition comprising between 0.0001 to 0.1 wt % of a hydrophobic dye and between 2 to 60 wt % of a surfactant, the hydrophobic dye of an anthraquinone structure, wherein the anthraquinone is other than one having an alkyl branched or linear alkyl chain of more than seven carbon atoms.

In another aspect the present invention provides a method of treating a textile, the method comprising the steps of: (i) treating a textile with an aqueous solution of the hydrophobic dye, the aqueous solution comprising from 1 ppb to 6 ppm of the hydrophobic dye and from 0.2 g/L to 3 g/L of a surfactant; and, (ii) rinsing and drying the textile. It is preferred that the hydrophobic dye is present in the range 10 ppb to 200 ppb. Preferably the aqueous solution has an ionic strength from 0.001 to 0.5. Most preferably In another aspect it is preferred that the aqueous solution also comprises from 1 ppb to 5 ppm one or more other dyes selected from cotton substantive shading dyes of group consisting of: hydrolysed reactive dye; acid dye; and direct dye.

A “unit dose” as used herein is a particular amount of the laundry treatment composition used for a type of wash, conditioning or requisite treatment step. The unit dose may be in the form of a defined volume of powder, granules or tablet or unit dose detergent liquid.

### DETAILED DESCRIPTION OF THE INVENTION

Hydrophobic dyes are defined as organic compounds with a maximum extinction coefficient greater than 1000 L/mol/cm in the wavelength range of 400 to 750 nm and that are uncharged in aqueous solution at a pH in the range from 7 to 11. The hydrophobic dyes are devoid of polar solubilizing groups. In particular the hydrophobic dye does not contain any sulphonic acid, carboxylic acid, or quaternary ammonium groups. The dye chromophore is an anthraquinone dye chromophore.

Many examples of hydrophobic dyes are found in the classes of solvent and disperse dyes.

Shading of white garments may be done with any colour depending on consumer preference. Blue and Violet are particularly preferred shades and consequently preferred dyes or mixtures of dyes are ones that give a blue or violet shade on white polyester.

It is preferred that the dye(s) have a peak absorption wavelength of from 550 nm to 650 nm, preferably from 570 nm to 630 nm. A combination of dyes which together have the visual effect on the human eye as a single dye having a peak absorption wavelength on polyester of from 550 nm to 650 nm, preferably from 570 nm to 630 nm. This may be provide for example by mixing a red and green-blue dye to yield a blue or violet shade.

A wide range of suitable solvent and disperse dyes are available. However detailed toxicological studies have shown that a number of such dyes are possible carcinogens, for example disperse blue 1. Such dyes are not preferred. More suitable dyes may be selected from those solvent and disperse dyes used in cosmetics. For example as listed by the European Union in directive 76/768/EEC Annex IV part 1. For example disperse violet 27 and solvent violet 13.

A preferred anthraquinone are of the following structure (I): 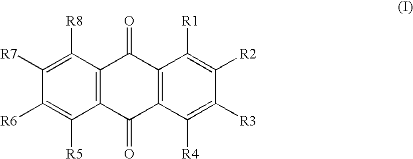
wherein R1, R4, R5, and R8 are independently selected from the groups consisting of —H, —OH, —NH₂, —NHR9, and —NO₂, such that a maximum of only one —NO2 group and a maximum of two —H are present as R1, R4, R5, and R8 substituents;

where R9 is an branched or linear C1-C7-alkyl chain or an aryl group or substituted aryl groups, or a branched or linear C1-C7-alkyl chain optionally substituted by an —OH group; R2, R3, R6, and R7 may be selected from —H, —F, —Br, —Cl, SO3aryl or —NO2, and —OR10, wherein R10 is selected from the group consisting of branched or linear C1-C7-alkyl or aryl; and, R2 and R3 may together be joined to form a five membered non-aromatic ring of the form —C(═O)N(HR11)C(═X)—, wherein X is O or NH and R11 is selected from the group consisting of C1-C6-alkyl optionally substituted with alkoxy groups.

It is preferred that the branched or linear alkyl chain of R9 and R10 have less than six carbon atoms. It is preferred that R1, R4, R5, and R8 are independently selected from the groups consisting of —H, —OH, —NH₂, and —NO₂, and R2, R3, R6, and R7 is selected from —H, F, Br, Cl or —NO₂, and —Oaryl. It is also preferred that the aryl is an optionally substituted phenyl. Of the R1, R4, R5 and R8 it is most preferred that is —OH and one is selected from —NH2 and —NHR9.

It is preferred that R2, R3, R5, R6, R7, and R8 are —H, R1=—OH, R4=—NHR9 or —NH2.

It is preferred that R5, R6, R7, and R8=—H, R1=R4=—NH2, R2=R3=—Oaryl, or —Cl.

It is most preferred that R11 is —CH2CH2CH2OMe.

The following are examples of preferred dyes: Solvent Violet 11, 13, 14, 15, 15, 26, 28, 29, 30, 31, 32, 33, 34, 26, 37, 38, 40, 41, 42, 45, 48, 59; Solvent Blue 11, 12, 13, 14, 15, 17, 18, 19, 20, 21, 22, 35, 36, 40, 41, 45, 59, 59:1, 63, 65, 68, 69, 78, 90; Disperse Violet 1, 4, 8, 11, 11:1, 14, 15, 17, 22, 26, 27, 28, 29, 34, 35, 36, 38, 41, 44, 46, 47, 51, 56, 57, 59, 60, 61, 62, 64, 65, 67, 68, 70, 71, 72, 78, 79, 81, 83, 84, 85, 87, 89, 105; Disperse Blue 2, 3, 3:2, 8, 9, 13, 13:1, 14, 16, 17, 18, 19, 22, 23, 24, 26, 27. 28, 31, 32, 34, 35, 40, 45, 52, 53, 54, 55, 56, 60, 61, 62, 64, 65, 68, 70, 72, 73, 76, 77, 80, 81, 83, 84, 86, 87, 89, 91, 93, 95, 97, 98, 103, 104, 105, 107, 108, 109, 11, 112, 113, 114, 115, 116, 117, 118, 119, 123, 126, 127, 131, 132, 134, 136, 140, 141, 144, 145, 147, 150, 151, 152, 153, 154, 155, 156, 158, 159, 160, 161, 162, 163, 164, 166, 167, 168, 169, 170, 176, 179, 180, 180:1, 181, 182, 184, 185, 190, 191, 192, 196, 197, 198, 199, 203, 204, 213, 214, 215, 216, 217, 218, 223, 226, 227, 228, 229, 230, 231, 232, 234, 235, 236, 237, 238, 239, 240, 241, 242, 243, 244, 245, 246, 247, 249, 252, 261, 262, 263, 271, 272, 273, 274, 275, 276, 277, 289, 282, 288, 289, 292, 293, 296, 297, 298, 299, 300, 302, 306, 307, 308, 309, 310, 311, 312, 314, 318, 320, 323, 325, 326, 327, 331, 332, 334, 347, 350, 359, 361, 363, 372, 377 and 379.

The composition may also comprise between 0.0001 to 0.1 wt % of one or more other dyes selected from cotton substantive shading dyes of group consisting of: hydrolysed reactive dye; acid dye; and direct dye. Example of preferred acid dyes are: acid blue 62, 40 and 290.

Balance Carriers and Adjunct Ingredients

The laundry treatment composition in addition to the dye comprises the balance carriers and adjunct ingredients to 100 wt % of the composition.

These may be, for example, surfactants, builders, foam agents, anti-foam agents, solvents, fluorescers, bleaching agents, and enzymes. The use and amounts of these components are such that the composition performs depending upon economics, environmental factors and use of the composition.

The composition may comprise a surfactant and optionally other conventional detergent ingredients. The composition may also comprise an enzymatic detergent composition which comprises from 0.1 to 50 wt %, based on the total detergent composition, of one or more surfactants. This surfactant system may in turn comprise 0 to 95 wt % of one or more anionic surfactants and 5 to 100 wt % of one or more nonionic surfactants. The surfactant system may additionally contain amphoteric or zwitterionic detergent compounds, but this in not normally desired owing to their relatively high cost. The enzymatic detergent composition according to the invention will generally be used as a dilution in water of about 0.05 to 2 wt %.

It is preferred that the composition comprises between 2 to 60 wt % of a surfactant, most preferably 10 to 30 wt %. In general, the nonionic and anionic surfactants of the surfactant system may be chosen from the surfactants described “Surface Active Agents” Vol. 1, by Schwartz & Perry, Interscience 1949, Vol. 2 by Schwartz, Perry & Berch, Interscience 1958, in the current edition of “McCutcheon's Emulsifiers and Detergents” published by Manufacturing Confectioners Company or in “Tenside-Taschenbuch”, H. Stache, 2nd Edn., Carl Hauser Verlag, 1981.

Suitable nonionic detergent compounds which may be used include, in particular, the reaction products of compounds having a hydrophobic group and a reactive hydrogen atom, for example, aliphatic alcohols, acids, amides or alkyl phenols with alkylene oxides, especially ethylene oxide either alone or with propylene oxide. Specific nonionic detergent compounds are C6 to C22 alkyl phenol-ethylene oxide condensates, generally 5 to 25 EO, i.e. 5 to 25 units of ethylene oxide per molecule, and the condensation products of aliphatic C₈ to C₁₈ primary or secondary linear or branched alcohols with ethylene oxide, generally 5 to 40 EO.

Suitable anionic detergent compounds which may be used are usually water-soluble alkali metal salts of organic sulphates and sulphonates having alkyl radicals containing from about 8 to about 22 carbon atoms, the term alkyl being used to include the alkyl portion of higher acyl radicals. Examples of suitable synthetic anionic detergent compounds are sodium and potassium alkyl sulphates, especially those obtained by sulphating higher C₈ to C₁₈ alcohols, produced for example from tallow or coconut oil, sodium and potassium alkyl C₉ to C₂₀ benzene sulphonates, particularly sodium linear secondary alkyl C₁₀ to C₁₅ benzene sulphonates; and sodium alkyl glyceryl ether sulphates, especially those ethers of the higher alcohols derived from tallow or coconut oil and synthetic alcohols derived from petroleum. The preferred anionic detergent compounds are sodium C₁₁ to C₁₅ alkyl benzene sulphonates and sodium C₁₂ to C₁₈ alkyl sulphates. Also applicable are surfactants such as those described in EP-A-328 177 (Unilever), which show resistance to salting-out, the alkyl polyglycoside surfactants described in EP-A-070 074, and alkyl monoglycosides.

Preferred surfactant systems are mixtures of anionic with nonionic detergent active materials, in particular the groups and examples of anionic and nonionic surfactants pointed out in EP-A-346 995 (Unilever). Especially preferred is surfactant system that is a mixture of an alkali metal salt of a C₁₆ to C₁₈ primary alcohol sulphate together with a C₁₂ to C₁₅ primary alcohol 3 to 7 EO ethoxylate.

The nonionic detergent is preferably present in amounts greater than 10%, e.g. 25 to 90 wt % of the surfactant system. Anionic surfactants can be present for example in amounts in the range from about 5% to about 40 wt % of the surfactant system.

Cationic Compound

When the present invention is used as a fabric conditioner it needs to contain a cationic compound.

Most preferred are quaternary ammonium compounds.

It is advantageous if the quaternary ammonium compound is a quaternary ammonium compound having at least one C₁₂ to C₂₂ alkyl chain.

It is preferred if the quaternary ammonium compound has the following formula: 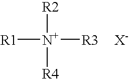
in which R¹ is a C₁₂ to C₂₂ alkyl or alkenyl chain; R², R³ and R⁴ are independently selected from C₁ to C₄ alkyl chains and X⁻ is a compatible anion. A preferred compound of this type is the quaternary ammonium compound cetyl trimethyl quaternary ammonium bromide.

A second class of materials for use with the present invention are the quaternary ammonium of the above structure in which R¹ and R² are independently selected from C₁₂ to C₂₂ alkyl or alkenyl chain; R³ and R⁴ are independently selected from C₁ to C₄ alkyl chains and X⁻ is a compatible anion.

A detergent composition according to claim 1 in which the ratio of (ii) cationic material to (iv) anionic surfactant is at least 2:1.

Other suitable quaternary ammonium compounds are disclosed in EP 0 239 910 (Proctor and Gamble).

It is preferred if the ratio of cationic to nonionic surfactant is from 1:100 to 50:50, more preferably 1:50 to 20:50.

The cationic compound may be present from 0.02 wt % to 20 wt % of the total weight of the composition.

Preferably the cationic compound may be present from 0.05 wt % to 15 wt %, a more preferred composition range is from 0.2 wt % to 5 wt %, and most preferably the composition range is from 0.4 wt % to 2.5 wt % of the total weight of the composition.

If the product is a liquid it is preferred if the level of cationic surfactant is from 0.05 wt % to 10 wt % of the total weight of the composition. Preferably the cationic compound may be present from 0.2 wt % to 5 wt %, and most preferably from 0.4 wt % to 2.5 wt % of the total weight of the composition.

If the product is a solid it is preferred if the level of cationic surfactant is 0.05 wt % to 15 wt % of the total weight of the composition. A more preferred composition range is from 0.2 wt % to 10 wt %, and the most preferred composition range is from 0.9 wt % to 3.0 wt % of the total weight of the composition.

It is most preferred that the present composition contains less than 0.1 wt % of any coloured inorganic electrolytes such as nickel or cupric sulphate. Most preferably the present composition is devoid of any coloured inorganic electrolytes.

Bleaching Species

The laundry treatment composition may comprise bleaching species. The bleaching species, for example, may selected from perborate and percarbonate. These peroxyl species may be further enhanced by the use of an activator, for example, TAED or SNOBS. Alternatively or in addition to, a transition metal catalyst may used with the peroxyl species. A transition metal catalyst may also be used in the absence of peroxyl species where the bleaching is termed to be via atmospheric oxygen, see, for example WO02/48301. Photobleaches, including singlet oxygen photobleaches, may be used with the laundry treatment composition. A preferred photobleach is vitamin K3.

Fluorescent Agent

The laundry treatment composition most preferably comprises a fluorescent agent (optical brightener). Fluorescent agents are well known and many such fluorescent agents are available commercially. Usually, these fluorescent agents are supplied and used in the form of their alkali metal salts, for example, the sodium salts. The total amount of the fluorescent agent or agents used in laundry treatment composition is generally from 0.005 to 2 wt %, more preferably 0.01 to 0.1 wt %. Preferred classes of fluorescer are: Di-styryl biphenyl compounds, e.g. Tinopal (Trade Mark) CBS-X, Di-amine stilbene di-sulphonic acid compounds, e.g. Tinopal DMS pure Xtra and Blankophor (Trade Mark) HRH, and Pyrazoline compounds, e.g. Blankophor SN. Preferred fluorescers are: sodium 2 (4-styryl-3-sulfophenyl)-2H-napthol[1,2-d]trazole, disodium 4,4′-bis{[(4-anilino-6-(N methyl-N-2 hydroxyethyl)amino 1,3,5-triazin-2-yl)]amino}stilbene-2-2′ disulfonate, disodium 4,4′-bis{[(4-anilino-6-morpholino-1,3,5-triazin-2-yl)]amino}stilbene-2-2′ disulfonate, and disodium 4,4′-bis(2-sulfoslyryl)biphenyl.

### EXAMPLES

### Example 1

Approximately 1000 ppm solutions of the dyes listed in the table below, were made in ethanol.

A stock solution of 1.8 g/L of a base washing powder in water was created. The washing powder contained 18% NaLAS, 73% salts (silicate, sodium tri-poly-phosphate, sulphate, carbonate), 3% minors including perborate, fluorescer and enzymes, remainder impurities and water. The solution was divided into 100 ml aliquots and the solvent dyes added from the ethanol solutions to give approximately 5.8 ppm solutions. 1 g of pure woven polyester fabric was added to each of the wash solutions and the solution then shaken for 30 minutes, rinsed and dried. From the colour of the fabric it was clear that dye had deposited to the fabric. To quantify this the colour was measured using a reflectance spectrometer and expresses as the deltaE value compared to a polyester washed analogously but without dye present.

The results are given below

| | Dye-ppm | |
|---|---|---|
| | in | |
| Dye | solution | deltaE |
| No dye (to indicate error level) | 0 | 0.2 |
| 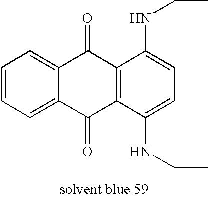 | 5.8 | 0.7 |
| 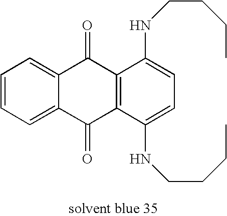 | 5.6 | 2.7 |
| 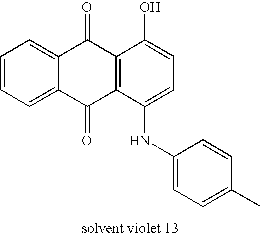 | 5.9 | 2.2 |
| 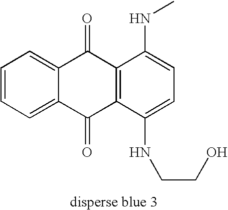 | 5.8 | 4.1 |

### Example 2

To examine the sensitivity of deposition to formulation components the experiment of Example 1 was repeated, except different wash solutions were utilised as outlined below, 4.9 ppm solvent violet 13 was used in solution and polyester fleece fabric was used. In all experiments washes were also conducted without dye, the colour of the cloth compared using a reflectometer and expressed as deltaE. The results are shown below.

| Wash conditions | deltaE |
|---|---|
| 0.3 g/L SDS surfactant | 7.0 |
| 0.3 g/L SDS surfactant + 3 g/L NaCl | 8.3 |
| 0.3 g/L SDS surfactant + 3 g/L NaCl + | 4.7 |
| pH adjusted to 10.5 using NaOH | |
| 0.3 g/L SDS surfactant + 3 g/L NaCl + | 4.2 |
| 0.5 g/L 7EO nonionic surfactant | |
| 1.6 g/L surfactant | 5.5 |

Dye was deposited to the polyester in all cases.

### Example 3

50 ppm solutions of the dyes listed in the table below, were made in ethanol. Concentration refers to dyes as received from the supplier. In general solvent dyes are pure (>90%) and disperse dyes have purities in the range 20-50%.

A stock solution of 1.8 g/L of a base washing powder in water was created. The washing powder contained 18% NaLAS, 73% salts (silicate, sodium tri-poly-phosphate, sulphate, carbonate), 3% minors including perborate, fluorescer and enzymes, remainder impurities and water. The solution was divided into 100 ml aliquots and the dyes added from the ethanol solutions with rapid stirring to give 200 ppb solutions. 1 g of pure knitted polyester fabric was added to each of the wash solutions and the solution then shaken for 30 minutes, rinsed and dried. From the colour of the fabric it was clear that dye had deposited to the fabric. To quantify this the colour was measured using a reflectance spectrometer and expresses as the delta E value compared to a polyester washed analogously but without dye present. Following the washes the Ganz whiteness of the cloth was also measured (see “assessment of Whiteness and Tint of Fluorescent Substrates with Good Instrument Correlation” Colour Research and Application 19, 1994). The experiments were repeated using woven nylon as a fabric. The results are displayed in the table below,

TABLE

| Dye | | | ΔE | | |
|---|---|---|---|---|---|
| Maximum visible absorption | OD | | poly | ΔE | |
| wavelength in ethanol given | 10 cm | Ganz | ester | nylon | CT |
| Control | 0 | 81 | 0.1 | 0.4 | — |
| 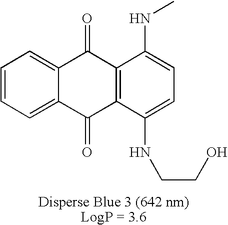 | 0.028 | 85 | 0.3 | 2.8 | 18 |
| 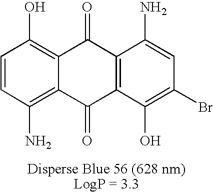 | 0.014 | 92 | 1.6 | 3.9 | 107 |
| 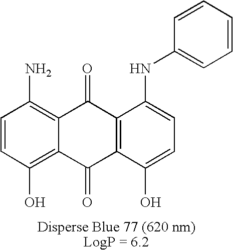 | 0.034 | 88 | 1.1 | 1.3 | 29 |
| 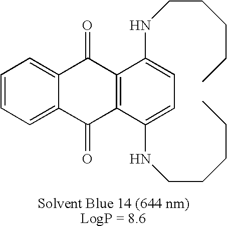 | 0.086 | 91 | 1.2 | 1.5 | 13 |
| 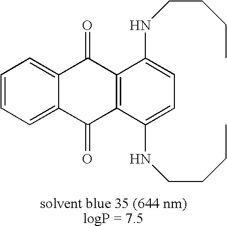 | 0.096 | 92 | 1.9 | 2.6 | 12.5 |
| 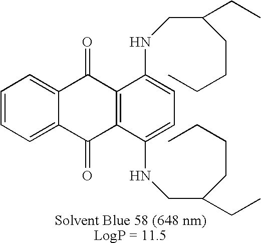 | 0.059 | 84 | 0.2 | 0.3 | 10 |
| 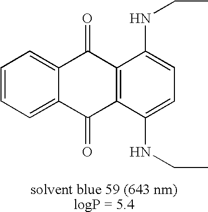 | 0.10 | 92 | 1.1 | 6.7 | 11 |
| 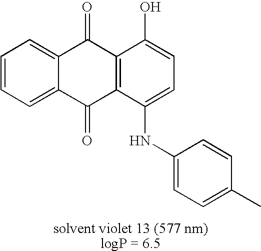 | 0.062 | 115 | 4.8 | 5.8 | 74 |
| 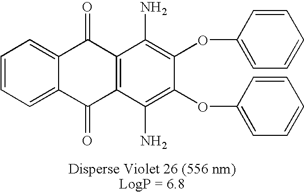 | 0.010 | 102 | 3.6 | 2.2 | 360 |
| 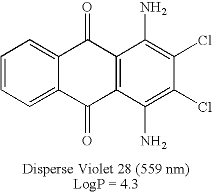 | 0.006 | 98 | 2.5 | 5.1 | 433 |
| 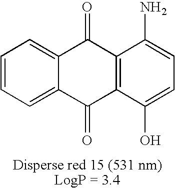 | 0.019 | 84 | 0.4 | 3.3 | 32 |

notes
The ganz whiteness values are accurate to +/− 5 units.
All deltaE measurements are UV excluded.

The optical density, OD, is that of a 200 ppb solution in water at 10 cm. The value was obtained by extrapolated from measurement in ethanol solutions at higher levels for accuracy.

CT is a measure of the Colour Transferred from the wash solution to the polyester and is defined as:
CT=deltaE/OD

From the deltaE results in the table all the dyes coloured the polyester. The blue and violet dyes all gave significant increases in the GANZ whiteness (>5 units) of the polyester, except solvent blue 58 and disperse blue 3. The C8 chains of solvent blue 58 clearly reduce the efficacy of this type of anthraquinone dye as compare to solvent blue 14 and 35. Solvent blue 58 is also more green as observed by the shift in its absorbance maximum, which is less favoured for shading benefits. The anthraquinone dyes of generic structure: 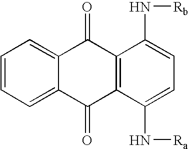
where the R groups are alkyl, show the worst performance in terms of colour transfer to the cloth.

### Example 4

The experiment of example 3 was repeated, but using 40 ppb of the dyes listed below. The L:C was changed to 30:1 and consisted by weight of 43% woven polyester and 57% non-mercerised cotton sheeting. The Ganz whiteness of the polyester were 96, and 87 for solvent violet 13 and disperse blue 56 respectively. Whiteness benefits were also observed on the cotton. Repetition of the experiment using nylon, also gave benefits.

1. A domestic wash method for shading a textile garment, the method comprising the steps of:
(i) treating a textile with an aqueous solution of a hydrophobic dye, the aqueous solution comprising from 1 ppb to 6 ppm of the hydrophobic dye and from 0.2 g/L to 3 g/L of a surfactant; and,
(ii) rinsing and drying the textile, wherein the hydrophobic dye is selected from solvent violet 13 and disperse violet 27 and an anthraquinone of the following anthraquinone structure (I): 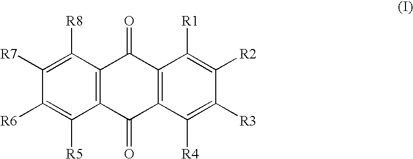
Wherein R1, R4, R5, and R8 are independently selected from the groups consisting of —H, —OH, —NH₂, and —NO₂, such that a maximum of only one —NO2 group and a maximum of two —H are present as R1, R4, R5, and R8 substituents;
And
R2, R3, R6, and R7 is selected from —H, F, Br, Cl or —NO₂, and —Oaryl, wherein the anthraquinone is other than one having an alkyl branched or linear alkyl chain or more than seven carbon atoms.

2. A domestic wash method according to claim 1, wherein aryl is an optionally substituted phenyl.

3. A domestic wash method according to claim 1, wherein at least one of R1, R4, R5 and R8 is —OH and one of R1, R4, R5 and R8 is selected from —NH2.

4. A domestic wash method according to claim 1, wherein R5, R6, R7, and R8=—H, R1=R4=—NH2, R2=R3=—Oaryl, or —Cl.

5. A domestic wash method according to claim 1, wherein the hydrophobic dye is selected from the group consisting of: solvent violet 13 and disperse violet 27.

6. A domestic wash method according to claim 1, wherein the dye gives a blue or violet shade when deposited on white polyester.

7. A domestic wash method according to claim 1, wherein the aqueous solution comprises a fluorescer.

8. A domestic wash method according to claim 7, wherein the fluorescer is selected from the group consisting of: sodium 2(4-styryl-3-sulfophenyl)-2H-napthol[1,2-d]trazole, disodium 4,4+-bis{[4-anilino-6-(N methyl-N-2 hydroxyethyl)amino 1,3,5-triazin-2-yl)]amino}stilbene-2-2′ disulfonate, disodium 4,4′-bix{[(4-anilino-6-morpholino-1,3,5-triazin-2-yl)]amino}stilbene-2-2′ disulfonate, and disodium 4,4′-bis(2-sulfoslyryl)biphenyl.

9. A domestic wash method according to claim 1, wherein the aqueous solution comprises one or more other dyes selected from cotton substantive shading dyes of group consisting of: hydrolysed reactive dye; acid dye; and direct dye.

10. A method of treating a textile according to claim 1, wherein the hydrophobic dye is present in the range 10 ppb to 20 ppb.

11. A method of treating a textile according to claim 1, wherein the aqueous solution has an ionic strength from 0.001 to 0.5.

12. A method of treating a textile according to claim 1, wherein the aqueous solution comprises from 1 ppb to 5 ppm one or more other dyes selected from cotton substantive shading dyes of group consisting of: hydrolysed reactive dye; acid dye; and direct dye.
